(19) United States
(12) Patent Application Publication
(10) Pub. No.: US 2018/0334850 A1
(43) Pub. Date: Nov. 22, 2018

(54) Roll Top and Method for the Production Thereof

(71) Applicant: fischer automotive systems GmbH & Co. KG, Horb a.N. (DE)

(72) Inventor: Ulf-Lothar Bastian, Pfalzgrafenweiler (DE)

(21) Appl. No.: 15/959,188

(22) Filed: Apr. 21, 2018

(30) Foreign Application Priority Data
May 17, 2017 (DE) 10 2017 110 662.6

(51) Int. Cl. E06B 9/08; B60R 7/04

(52) U.S. Cl. CPC E06B 9/08; E06B 2009/1533; B32B 2605/003; B60R 7/04

(57) ABSTRACT

The invention relates to a roll top for a storage compartment in a center console of a motor vehicle and proposes to injection mold lamellae of the roll top in two layers from a hard plastic, and to subsequently mold joints made of an elastomer onto one of the two layers. A distance between a layer of the lamellae and the joints prevents the soft plastic of the joints, which is liquid during injection molding, from flowing onto this layer. As a result, a visible side of the roll top can be kept free of the soft plastic of the joints, and the soft plastic is prevented from flowing beneath a decorative layer applied by way of in-mold.

### CROSS-REFERENCE TO RELATED APPLICATION

The present application claims priority under 35 USC § 119 to German Patent Application No. 10 2017 110 662.6, filed on May 17, 2017, the entire disclosure of which is incorporated herein by reference.

### TECHNICAL FIELD

The invention relates to a roll top comprising articulated lamellae, which is provided, for example, for closing a storage compartment in a motor vehicle or a cabinet. Furthermore, the invention relates to a method for producing such a roll top.

### RELATED ART

Roll tops of this type are known. They comprise strip-shaped lamellae, which are disposed in a planar and/or curved surface and are connected to one other in an articulated manner at the mutually facing edges thereof. The mutually facing edges of the lamellae extend transversely to a movement direction of the roll top. Edges of the lamellae on longitudinal sides of the roll top are movably guided in grooves, which are located in two planes that are parallel to one another. The grooves are open on mutually facing sides, may extend in a straight or curved manner in the two mutually parallel planes, and are congruent, as viewed from one side. Slide guidance mechanisms or straight and/or curved linear guidance mechanisms other than grooves are possible.

### SUMMARY

It is the object of the invention to propose such a roll top and a method for the production thereof, having lamellae that are articulated by way of soft plastic.

The roll top according to the invention comprises lamellae made of hard plastic, which are connected to one other in an articulated manner by way of joints made of soft plastic. The lamellae are integrally joined to the joints by injection molding of the lamellae and the joints. A hard plastic differs from a soft plastic in that the hard plastic is more flexurally rigid than the soft plastic, and the soft plastic allows the lamellae to pivot with respect to one another, as a result of deformation of the soft plastic, by a pivoting angle that allows the roll top to be moved through all straight lines and curves of a slide guidance mechanism of the lamellae of the roll top. A hard plastic for the lamellae is polycarbonate (PC) or acrylonitrile butadiene styrene (ABS) copolymer, for example, or another plastic material having a hardness or stiffness in the order of magnitude of polycarbonate or ABS. Soft plastics for the joints are elastomers, for example, or other plastic materials having the same or similar elasticity.

At least one of the lamellae, and preferably several, a plurality, or all of the lamellae are injection molded in at least two layers. For example, all of the lamellae, or all of the lamellae except for a first lamella and/or a last lamella, of the roll top are injection molded in at least two layers. One of the layers of the at least one lamella is located at a distance from the joints which it connects to the adjoining lamellae in an articulated manner. This distance between a layer of the at least one lamella injection molded in at least two layers and the joints enables reliable sealing of cavities for the lamellae in an injection mold, in which the lamellae are inserted and the joints are injection molded to the lamellae. During injection molding, there is a risk that the soft plastic of the joints, which is liquid during injection molding, flows onto the lamellae. The invention avoids this risk for the layer of the at least one lamella of the roll top, which is located at a distance from the joints. The invention enables the production of a roll top having lamellae which are integrally joined and articulated by way of joints made of a soft plastic, in which one side of the roll top is free of the soft plastic of the joints. Preferably, this “pretty” side of the roll top is used as the visible side, which is to say the side that is visible when the roll top is closed, for example, or from the outside. In general, the visible side of the roll top is the side which is subject to higher demands in terms of the appearance thereof.

The at least two layers of the at least one lamella may be made of differing plastic materials. Preferably, they are made of the same plastic material, so that only one extruder is needed for injection molding the lamellae.

Preferably, a layer of the at least one lamella which is molded first is located on a visible side of the roll top, since deformation due to shrinkage is thus lower on the visible side, and a visually superior surface compared to a layer that is molded last is achieved.

One embodiment of the invention provides a decorative layer attached to a visible side of the roll top by way of in-mold decoration (IMD). The decorative layer may cover the visible side of one, more than one, or all of the lamellae. This may be interrupted at the joints or may continue across the joints. In-mold decoration means that, prior to injection molding the lamellae, a decorative layer is introduced into an injection mold, and subsequently the lamellae are injection molded. The decorative layer is a film, for example, which adheres to a cavity of the injection mold during the injection of plastic material and integrally bonds with the plastic material, serving as a surface and decorative layer. On the side onto which the plastic material is molded, the film can include a paint layer or an imprint, which remains on the plastic material, serving as the decorative layer, after injection molding, while the film serves as a carrier for the paint or the imprint and is removed after injection molding. The film may also form the decorative layer of the lamellae of the roll top and may remain on the lamella after injection molding. Another option is to apply paint, prior to injection molding, to an area of an injection mold which forms the visible side of the roll top. The paint integrally bonds with the plastic material of the lamellae during injection molding, forming the decorative layer. The list is by way of example and not exhaustive.

In one embodiment of the invention, the at least two layers of the at least one lamella are at least as thick as 7%, 10%, 12%, 15%, 20%, 25% or 33% of the thickness of the lamella. This determination is intended to convey that the at least two layers of the at least one lamella have a noteworthy thickness in relation to the thickness of the lamella. Additional further layers, including thinner layers, are not excluded. Another definition is that the at least two layers of the at least one lamella are at least one tenth of a millimeter, preferably several tenths of a millimeter, at least half a millimeter, 0.7 or 0.8 mm, or at least 1 mm thick. According to still another definition, the at least two layers of the at least one lamella are several times as thick as a decorative layer of the roll top, or of the lamellae thereof. For example, the at least two layers are at least 10 times, several 10 of times, 100 times or several 100 of times as thick as a decorative layer of the roll top, or of the lamellae thereof.

To produce the roll top, the method according to the invention having the characteristics of claim 7 provides for at least one lamellae of the roll top to be injection molded in two layers, wherein preferably a layer on a visible side of the roll top is molded first. Preferably, the at least two layers are molded from the same hard plastic, and preferably using one extruder. The molding of the two layers may take place in an injection mold, wherein the first layer is molded with cores inserted into the injection mold, and the second layer is molded after the cores have been removed. It is also possible for the first layer to be molded in an injection mold, and the second layer to be molded in a second injection mold after the first layer has been transferred, or for one of two mold halves to be replaced prior to molding the second layer.

Thereafter, the joints, which connect the lamellae to one another in an articulated manner, are injection molded from a soft plastic, which is molded onto the lamellae. The joints can be injection molded in a dedicated injection mold, into which the lamellae are introduced after the two layers of the lamellae have been injection molded, or they are injection molded in an injection mold in which the second layer of the lamellae was injection molded, after cores have been pulled out. The cores are pulled far enough out of the injection mold that cavities for the joints are created.

During injection molding of the joints, a layer, which is preferably injection molded first, of the at least one lamella of the roll top is located at a distance from joints that connect the at least one lamella in an articulated manner to adjoining lamellae, so as to avoid the soft plastic of the joints, which is liquid during injection molding, flowing onto this layer of the lamellae.

A refinement of the method according to the invention provides a decorative layer to be applied to the lamellae by way of in-mold decoration.

### BRIEF DESCRIPTION OF THE DRAWINGS

The invention will be described in more detail hereafter based on an exemplary embodiment shown in the drawings. In the drawings:

FIG. 1 shows a roll top according to the invention in a side view; and

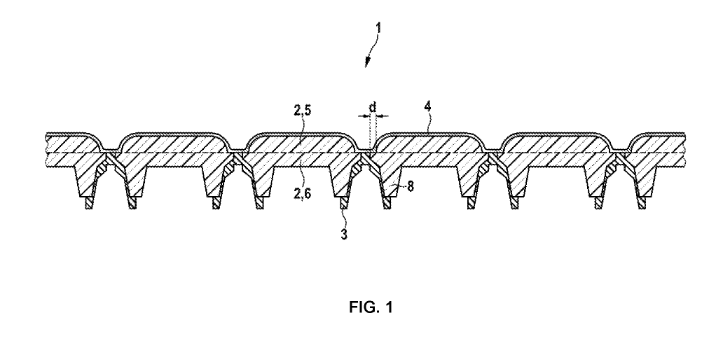

FIG. 2 shows an enlarged illustration of the roll top in the region of a joint.

### DETAILED DESCRIPTION

The roll top 1 according to the invention shown in the drawing is provided, for example, to close a storage compartment (not shown) in a center console of a motor vehicle. It comprises strip-shaped, mutually parallel lamellae 2 in a planar and/or curved surface, which are articulated by joints 3. The lamellae 2 are made of a hard plastic, such as polycarbonate (PC) or acrylonitrile butadiene styrene (ABS) copolymer, and the joints 3 are made of a soft plastic, for example an elastomer, and in particular a thermoplastic elastomer (TPE).

The roll top 1 is injection molded, which is to say the lamellae 2 and the joints 3 are injection molded, wherein the joints 3 made of the soft plastic are molded to the lamellae 2, which were previously injection molded in two layers from the hard plastic, so that the joints 3 integrally join and connect the lamellae 2 in an articulated manner, which is to say connect these so as to pivot with respect to one another. On a side of the roll top 1 referred to as the visible side here, the roll top 1 comprises a film as a decorative layer 4, which is applied by way of in-mold decoration. In-mold decoration means that the decorative layer 4 is introduced into an injection mold (not shown) prior to injection molding the lamellae 2, and subsequently, on a side of the decorative layer 4, the hard plastic primary-shaping the lamellae 2 is injected into the injection mold and onto the one side of the decorative layer 4. The hard plastic causes the decorative layer 4 to adhere to a surface of a cavity of the injection mold.

In a first so-called shot, a first layer 5 of the lamellae 2 is molded onto the decorative layer 4 on the visible side of the roll top 1. The visible side of the roll top 1 is the side comprising the decorative layer 4. In a second shot, a further layer 6 of the lamellae 2 is molded onto a side of the first layer 5 facing away from the decorative layer 4 and the visible side of the roll top 1, this further layer integrally joining with the first layer. By replacing the mold half facing away from the decorative layer 4, the further layer 6 can be molded in a cavity that becomes available as a result of the replacement. The two layers 5, 6 of the lamellae 2 of the roll top 1 are made of the same hard plastic and can be injection molded using the same extruder. The further layer 6 of the lamellae 2 protrudes over the first layer 5 of the lamellae 2 in the direction of adjoining lamellae 2, so that the first layer 5 is located at a distance d from the joints 3.

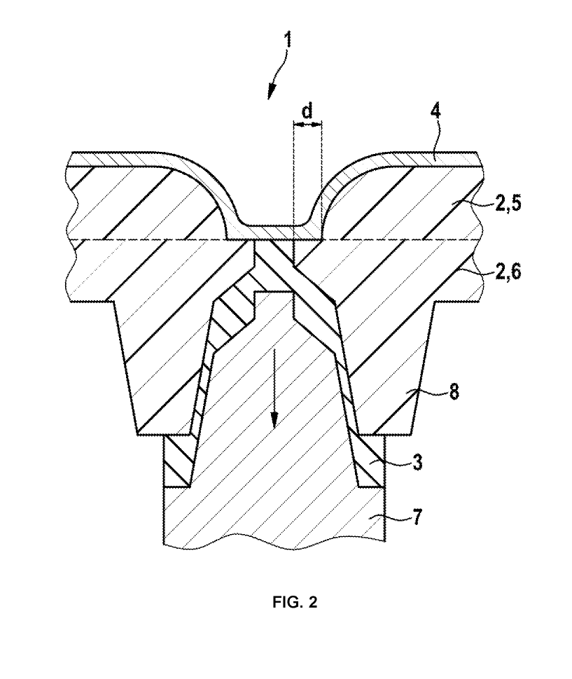

Spaces, into which the soft plastic which primary-shapes the joints 3 is injected in a third, further shot, are present between the lamellae 2 of the roll top 1 after the two layers 5, 6 of the lamellae 2 have been injection molded. The joints 3 can be molded in a further injection mold or, after cores 7 have been pulled, in the same mold as the further layer 6 of the lamellae 2. Such a core 7 is shown in FIG. 2 without the remaining injection mold. “Pulling” means moving the cores 7 out of the injection mold by a thickness of the joints 3. The soft plastic primary-shaping the joints 3 is molded onto mutually facing surfaces of the further layers 6 of the lamellae 2 of the roll top 1 and integrally bonds with the further layers 6, so that the joints 3 connect the lamellae 2 in an articulated manner as a result of the elasticity of the soft plastic. The distance d between the first layer 5 of the lamellae 2 and the joints 3 prevents the soft plastic of the joints 3, which is liquid during injection molding, from flowing beneath the decorative layer 4 onto the first layer 5 of the lamellae 2. Even if the lamellae 2 are produced without a decorative layer 4, the distance d between the first layer 5 of the lamellae 2 and the joints 3 prevents the soft plastic primary-shaping the joints 3 during injection molding from flowing onto the first layer 5 of the lamellae 2. Thus, one side of the roll top 1 and of the lamellae 2 remains free of the soft plastic of the joints 3, at least in the region of the first layer 5 of the lamellae 2. This side can be used as the visible side.

The film forming the decorative layer 4 may be imprinted or metallized, or may be a metal foil, for example. The list is by way of example and not exhaustive. The film can also comprise a paint layer or an imprint, and can be removed from the roll top 1 after injection molding, so that the paint layer or the imprint remains as a decorative layer 4 on the visible side of the roll top 1. As shown, the film can extend across the lamellae 2 and the joints 3 or, in contrast to what is shown, can be applied only to the lamellae 2 and be interrupted at the joints 3.

In the exemplary embodiment, the two layers 5, 6 of the lamellae 2 of the roll top 1 have approximately the same thickness outside of reinforcement ribs 8, which protrude from a side of the further layer 6 of the lamellae 2 facing away from the first layer 5.

### LIST OF REFERENCE NUMERALS

### Roll Top and Method for the Production Thereof

d distance
1 roll top
2 lamella
3 joint
4 decorative layer
5 first layer
6 further layer
7 core
8 reinforcement rib

1. A roll top comprising lamellae made of hard plastic, which are connected in an articulated manner by joints made of soft plastic, wherein the lamellae are integrally joined to the joints by injection molding of the lamellae and of the joints, at least one lamella being injection molded in at least two layers, and a layer of the at least one lamella being located at a distance from the joints.

2. The roll top according to claim 1, wherein the at least two layers of the at least one lamella are made of the same plastic material.

3. The roll top according to claim 1, wherein a layer of the lamellae is located at a distance from the joints on a visible side of the roll top.

4. A roll top according to claim 1, wherein a layer of the at least one lamella which is molded first is located on a visible side of the roll top.

5. A roll top according to claim 1, wherein the at least one lamella comprises a decorative layer on a visible side, which is applied by way of in-mold decoration.

6. A roll top according to claim 1, wherein layer thicknesses of the at least two layers of the at least one lamella are at least 7% of the thickness of the at least one lamella.

7. A method for producing a roll top comprising lamellae made of hard plastic, which are connected in an articulated manner by joints made of soft plastic, wherein the lamellae are injection molded in two layers, and thereafter the joints are injection molded, and a layer of the lamellae is located at a distance from the joints.

8. The method according to claim 7, wherein, prior to injection molding the lamellae, a decorative layer is introduced into an injection mold.
